(19) United States
(12) Patent Application Publication
(10) Pub. No.: US 2018/0335780 A1
(43) Pub. Date: Nov. 22, 2018

(54) PERSONAL WATERCRAFT AUTO-RETURN SYSTEM

(71) Applicants: John Stevens, Winter Park, FL (US); C Robert Reiss, Orlando, FL (US)

(72) Inventors: John Stevens, Winter Park, FL (US); C Robert Reiss, Orlando, FL (US)

(21) Appl. No.: 15/712,221

(22) Filed: Sep. 22, 2017

Related U.S. Application Data
(60) Provisional application No. 62/507,447, filed on May 17, 2017.

(51) Int. Cl. G05D 1/02; G05D 1/00; B63H 21/21; B63C 9/00

(52) U.S. Cl. CPC G05D 1/0206; G05D 1/0088; B63B 2035/004; B63C 9/0005; B63H 21/21

(57) ABSTRACT

A personal watercraft auto-return system includes a user device having a rider location determination unit, a user interface, and a communication unit. The system also includes an autopilot unit that is positioned within a personal watercraft. The autopilot unit including a steering unit for controlling the steering the watercraft, and a controller having a processor and memory for controlling the engine and throttle controls of the watercraft. The controller selectively activates the steering unit, engine, and throttle of the personal watercraft to navigate to the location of the user device upon receiving a request from the user interface.

### CROSS-REFERENCE TO RELATED APPLICATIONS

This application claims the benefit of U.S. Application Ser. No. 62/507,447 filed on May 17, 2017, the contents of which are incorporated herein by reference.

### TECHNICAL FIELD

The present invention relates generally to watercraft safety systems, and more particularly to a system for providing automated “return to rider” functionality for personal watercraft (PWC).

### BACKGROUND

The statements in this section merely provide background information related to the present disclosure and may not constitute prior art.

Personal watercraft are extremely popular for their ease of use, relatively low maintenance, and low operating costs compared to other types of water vessels. As such, they are often the first type of powerboat that the average person will operate. Although small in size compared to passenger boats, personal watercraft are extremely fast and can often have top speeds that exceed 50-75 miles per hour.

As a safety precaution, modern personal watercrafts are equipped with an engine kill switch that is coupled to a safety lanyard worn by the rider. In the event the rider becomes separated from the craft (a common occurrence), the lanyard removes the kill switch and the engine automatically shuts down. Depending on the speed the craft was traveling, it is not uncommon for riders to have to swim dozens or even hundreds of feet to get back to the craft, as the momentum will continue after the engine has been shut down.

To this end, there are many documented cases where riders have been unable to swim to their craft. In some cases the rider was injured by the fall and was unable to swim at all. In other cases, high winds, strong currents, and other such conditions carried the craft away, thereby stranding the rider in the body of water.

Accordingly, it would be beneficial to provide a system for allowing a rider to instruct a PWC to return to their location after becoming separated from the craft, so as to overcome the issues described above.

### SUMMARY OF THE INVENTION

The present invention is directed to a personal watercraft auto-return system. One embodiment of the present invention can include an autopilot unit that is positioned within a personal watercraft. The autopilot unit including a steering unit for controlling the steering the watercraft, and a PWC controller for controlling the engine and throttle controls of the watercraft. The autopilot unit can also include a location determination for identifying the location of the watercraft and a processor for calculating a route to the user device.

In one embodiment, the system can also include a user device having a rider location determination unit. The user device can also include a user interface for receiving user instructions, and a communication unit for sending the location of the rider to the autopilot unit.

In one embodiment, the PWC controller can selectively activate the steering unit, engine, and throttle of the personal watercraft to navigate to the location of the user device.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a personal watercraft auto-return system that is useful for understanding the inventive concepts disclosed herein.

FIG. 2 is a schematic side elevational view of a watercraft illustrating portions of a control system and the autopilot unit of the system, in accordance with one embodiment of the invention.

FIG. 3 is a simplified block diagram of the internal controller of the autopilot unit of the system, in accordance with one embodiment of the invention.

FIG. 4 is a front view of the user device of the system in accordance with one embodiment of the invention.

FIG. 5 is a simplified block diagram of the internal controller of the user device of the system, in accordance with one embodiment of the invention.

FIG. 6 is a perspective view of the personal watercraft auto-return system in operation, in accordance with one embodiment of the invention.

FIG. 7 is a block diagram illustrating an exemplary method of utilizing the personal watercraft auto-return system, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

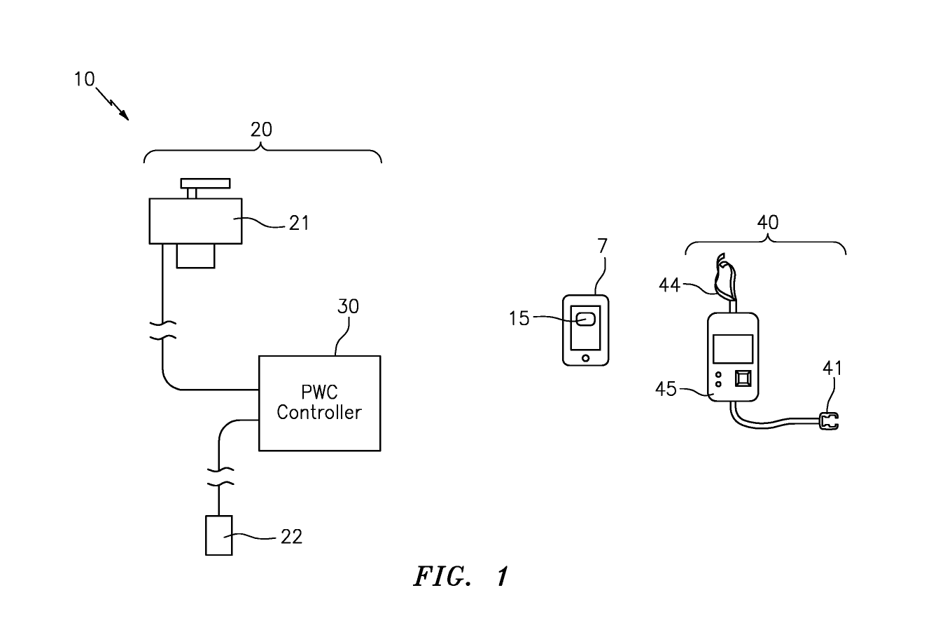

FIGS. 1-7 illustrate one embodiment of a personal watercraft auto-return system 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in FIG. 1, the system 10 can include, essentially, an autopilot unit 20 having a steering unit 21, a PWC location determination unit 22, and a PWC controller 30, that is in communication with a mobile application 15 and/or a user location device 40. As will be described below, the system 10 can function to allow a rider who has fallen off of a watercraft to send location information to the craft, and to instruct the craft to automatically travel to the location of the user. In this regard, the system can be incorporated into the new construction of a watercraft, or can be installed as an aftermarket component for upgrading an existing watercraft with the below described functionality.

Although illustrated with regard to a personal watercraft, other embodiments are contemplated for allowing the inventive concepts discussed herein to be applied to other forms of waterborne conveyances, such as passenger boats, hovercraft, motorized paddleboards, and the like.

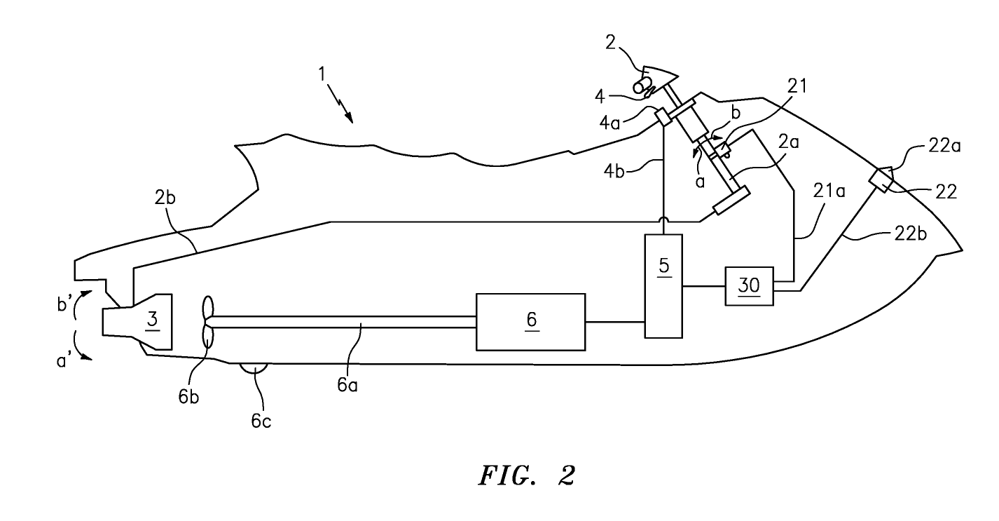

FIG. 2 illustrates one embodiment of a personal watercraft 1 that includes a bar-type steering handle 2 having an elongated steering shaft 2a that is mechanically coupled 2b to the engine nozzle 3. A throttle lever 4 and various user control inputs 4a, such as an ON/OFF switch, for example are communicatively coupled 4b to an onboard computer 5, such as an Engine Control Unit (ECU). In this regard, the throttle lever 4 and ECU 5 function as a “fly-by-wire” type of system by sending electrical signals to engine 6 to spin the impeller shaft 6a and impeller 6b.

In one embodiment, the steering unit 21 can be physically coupled to the steering shaft 2a of the PWC 1, and/or other such steering components. The steering unit can function to manipulate/rotate the position of the shaft 2a upon receiving an instruction from the PWC controller 30. This manipulation will preferably include the full range of motion that can be imparted onto the steering shaft by a user operating the steering handle 2 in order to cause the craft to turn right and left.

In this regard, the steering unit can be communicatively linked 21a to the PWC controller 30 and can function to selectively rotate the shaft clockwise (arrow a) and counterclockwise (arrow b), for example, to cause the engine nozzle to transition between a right turn orientation (arrow a′) and a left turn orientation (arrow b′), respectively. As described herein, the steering unit 21 can include any number of different components capable of receiving electrical instructions to manipulate a position of a secondary object. One suitable example of a steering unit for use with the system 10 includes the GSA 28 Smart Autopilot Servo that is commercially available from Garmin, Ltd. Of course, any number of other devices capable of performing this functionality are also contemplated.

The PWC location determination unit 22 can include any number of different components for capturing location information. In the preferred embodiment, the unit 22 can include a satellite communication unit capable of accessing one or more systems such as the Global Positioning System (GPS), Galileo, Beidou, GLONASS, and/or cellular telephone based location information and coordinates, for example. The unit can include an antenna 22a and can be communicatively linked 22c to the PWC controller 30.

As will be described below, the unit 20 can function to receive location information pertaining to the location of the PWC 1 to which it is secured, and the location of the user unit 40, so as to function as a real time location identification and tracking unit. The use and operation of satellite navigation and tracking systems are well known in the art.

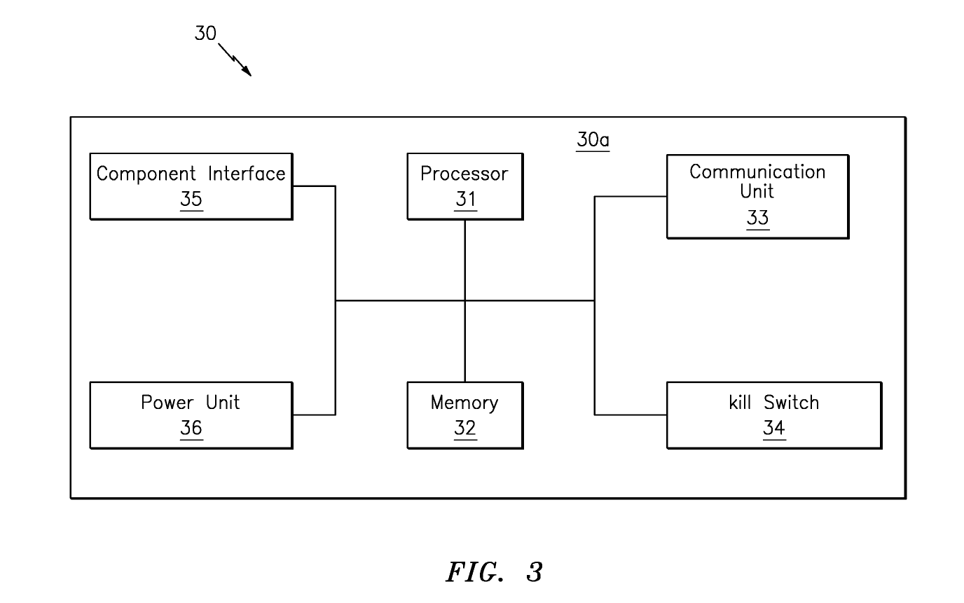

FIG. 3 illustrates one embodiment of the PWC controller 30. As shown, the controller can include an outer shell/body 30a having a processor 31 that is conventionally connected to an internal memory 32, a communication unit 33, an optional kill switch 34, a component interface unit 35, and/or a power unit 36.

Although illustrated as separate elements, those of skill in the art will recognize that one or more system components may comprise, or include one or more printed circuit boards (PCB) containing any number of integrated circuit or circuits for completing the activities described herein. The CPU may be one or more integrated circuits having firmware for causing the circuitry to complete the activities described herein. Of course, any number of other analog and/or digital components capable of performing the below described functionality can be provided in place of, or in conjunction with the below described controller elements.

The main body 30a can include any number of different shapes and sizes, and can be constructed from any number of different materials suitable for encompassing each of the controller elements. In one preferred embodiment, the main body 30a can be constructed from lightweight injection molded plastic having a plurality of internal connectors (not shown) for securely housing each of the device elements in a watertight and shock resistant manner. Of course, any number of other known construction materials are also contemplated.

The processing unit 31 can be a conventional central processing unit (CPU) or any other type of device, or multiple devices, capable of manipulating or processing information such as program code stored in the memory 32 in order to allow the device to perform the functionality described herein. Likewise, a timer module can be provided as a function of the processor, and can function to accurately measure the passage of time. Processors and timers are extremely well known in the art, therefore no further description will be provided.

Memory 32 can act to store operating instructions in the form of program code for the processor 31 to execute. Although illustrated in FIG. 3 as a single component, memory 32 can include one or more physical memory devices such as, for example, local memory and/or one or more bulk storage devices. As used herein, local memory can refer to random access memory or other non-persistent memory device(s) generally used during actual execution of program code, whereas a bulk storage device can be implemented as a persistent data storage device such as a hard drive, for example, containing programs that permit the processor to perform the functionality described below. Additionally, memory 32 can also include one or more cache memories that provide temporary storage of at least some program code in order to reduce the number of times program code must be retrieved from the bulk storage device during execution. Each of these devices are well known in the art.

To this end, the memory can be encoded with instructions for receiving and storing information from the PWC location unit 22 and/or the communication unit 33 pertaining to the location of the PWC 1 to which the system is secured, and the location of the user device 40 that is paired with the system. The memory can also include any number of operating instructions for calculating the distance, trajectory and other such separation parameters between the PWC and the user device to perform a trilateration of the respective devices and plot a course to the location of the user device. The memory can also be encoded with instructions for instructing the ECU of the PWC to which it is attached to activate the engine 6 and engage the throttle controls. As will be described below, this location information can be utilized to instruct the throttle control of the ECU and the steering unit 21 to pilot the PWC 1 to the location of the user device 40.

The communication unit 33 can include any number of components capable of sending and/or receiving electronic signals with an externally located device, in either a wired or wireless manner. For example, the communication unit can include the ability to send and/or receive radio signals such as an emergency beacon, for example, that can be transmitted to or from the user device 40. The signal can be utilized by the memory and processor to generate navigation instructions for piloting the PWC to the user device.

In one embodiment, the communication unit can include a wireless transceiver such as a Bluetooth transceiver, for example, capable of communicating wirelessly with an external portable electronic device 7 such as a smartphone, or smartphone watch, for example. To this end, various embodiments of the system 10 can include a PWC autopilot application 15 (i.e., App) which can be loaded onto a portable electronic device 7.

In this regard, the App can include program language for execution on the device that enables a user of the device to summon the PWC to their location in lieu of or in conjunction with the user device 40 in the manner described herein. Although outside the scope of this application, it is important to note that vigorous security, verification and authentication methodologies will be implemented to allow such communication to ensure an unauthorized user cannot access the autopilot features.

In another embodiment, the communication unit and/or satellite unit can function to broadcast an emergency distress signal with the location of the PWC, so as to request immediate assistance and/or rescue. The distress signal can be on any number of designated emergency frequencies and can add emergency functionality to the overall system.

Of course, any number of other known transmission and reception mechanisms and protocols can also be utilized herein. Several nonlimiting examples include Near-Field-Communication (NFC) devices, and/or unique radio frequencies, for example. Moreover, the communication unit can also function to interface with a manufacturer, for example, in order to send or receive data, program updates and other such software.

The kill switch 34 can include any number of commercially available 2 or 3 axis orientation sensors capable of detecting and reporting the orientation of the PWC 1 to the processor 31. In this regard, the memory and processor can be encoded with instructions to not activate the engine 6 if the kill switch indicates that the PWC is upside down or tilted beyond a set threshold (e.g., 50 degrees). Such a feature advantageously ensures the PWC will not sustain damage by operating without sufficient water to the intake 6c, for example.

The component interface unit 35 can function to provide a communicative link between the processor 31 and various other components such as the ECU 5, the steering unit 21, the satellite unit 22, the communication unit 33 and/or the kill switch 34, for example. In this regard, the component interface unit can include any number of different components such as one or more PIC microcontrollers, internal bus, USB connections and other such hardware 35a capable of providing a direct link between the various components. Of course any other means for providing the two way communication between the identified components can also be utilized herein.

The power unit 36 can include any number of different components capable of providing and/or connecting the necessary power requirements to each element of the system. In the preferred embodiment, the power unit can comprise a power cable having a connector for mating with the onboard electronics/batteries of the PWC 1 to which the system will be mated. Such a feature allowing the system 10 to operate from the PWC power during operation. Of course, other embodiments are contemplated wherein the power unit includes or comprises one or more independent batteries which may be positioned anywhere within the PWC body to independently provide power to the system components.

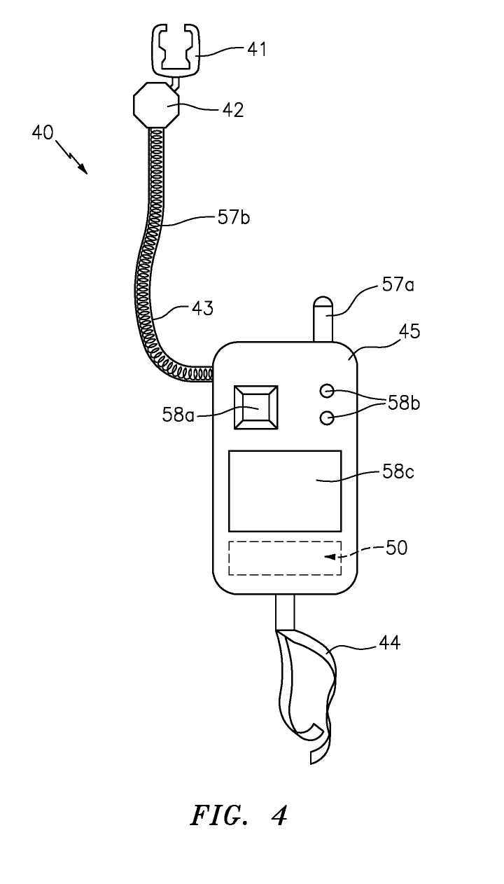

FIG. 4 illustrates one embodiment of the user device 40. The device can preferably take the form of a portable PWC safety lanyard having a safety switch 41 for engaging the control input 4a, causing the PWC to shut down when removed. The device can also include an optional computer proximity chip 42 such as a DESS key, for example, an elongated tether 43, a user attachment mechanism 44 such as a clip or wristband, for example, and a user interface housing 45 having an internal controller 50.

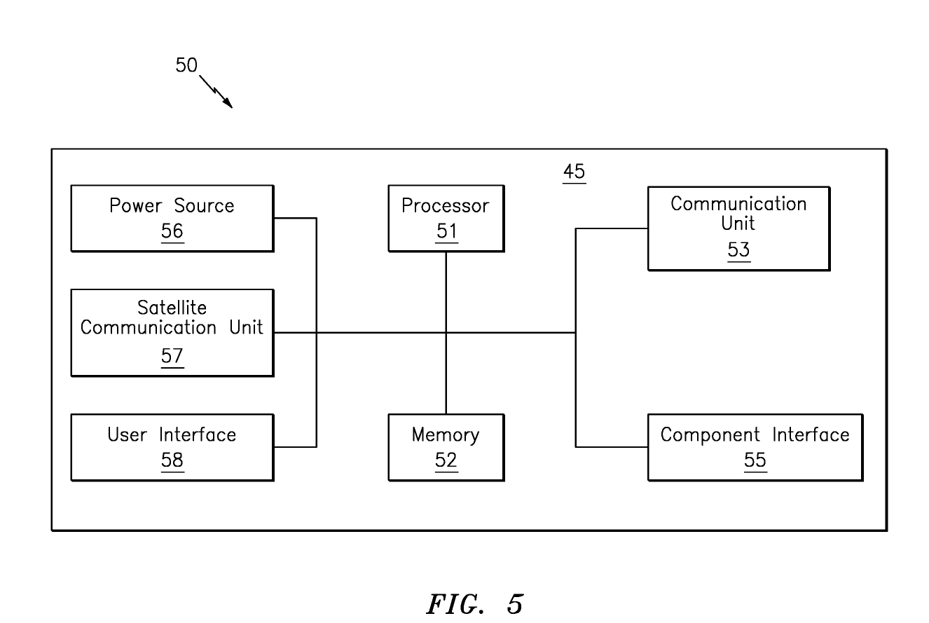

As shown in FIG. 5, the internal controller 50 can also include a processor 51 that is conventionally connected to an internal memory 52, a communication unit 53, a component interface unit 55, a power source 56, a user location determination unit 57, and a user interface 58.

The interface housing 45 can act to securely position each of the elements 51-58 in a compact and watertight manner. It is preferred that the body 45 be as small as possible, preferably between 0.5 and 4 inches in both, length, width and thickness. It is also preferred that the body 45 be lightweight, e.g., between 0.1 and 1 pounds, for example, so as to not interfere with the ability of a user to swim while wearing the device 40.

As described herein, the processor 51, memory 52, communication unit 53 and component interface unit 55 can be substantially identical to the above noted processor 31, memory 32, communication unit 33 and component interface unit 35, respectively.

The power source 56 can preferably include a battery that is positioned within the housing 45 and capable of providing the necessary power requirements to the unit.

The rider location determination unit 57 can be substantially identical to the above noted PWC location determination unit 22. The unit 57 can preferably be small/compact enough to fit within the small housing 45, and can include an antenna 57a that is secured to the housing body and/or an antenna 57b that is positioned within the tether 43. Such a feature providing greater reception and transmission capabilities for the device. One example of a suitable unit includes the ECCO® personal pocket GPS locator system that is commercially available from Audiovox®, for example, however other such systems are contemplated.

The user interface 58 can function to accept user inputs to provide operating instructions to the unit. In various embodiments, the user interface can include or control one or more buttons/switches 58a, that are connected to the processor 51 so as to activate various programmatic functions. In addition to the above, the user interface can further include or control any number of lights 58b so as to clearly indicate whether the device is in the ON or OFF operating state, and/or whether the autopilot unit 20 is in operation (e.g., currently driving to the user location). Moreover, the user interface can include or control any number of visual displays such as a touch screen Graphic User Interface (GUI) 58c, for example, that is capable of performing two way communication with a device user. Such a feature can enable the user to take manual control of the PWC, for example, so as to remotely direct the movement of the same utilizing the autopilot unit 20. Such a feature being particularly advantageous in situations where a docked or beached watercraft floats away, by allowing the operator to remotely steer the craft around any obstructions (e.g., piers, jetty, etc.,) while piloting the craft back to the user location.

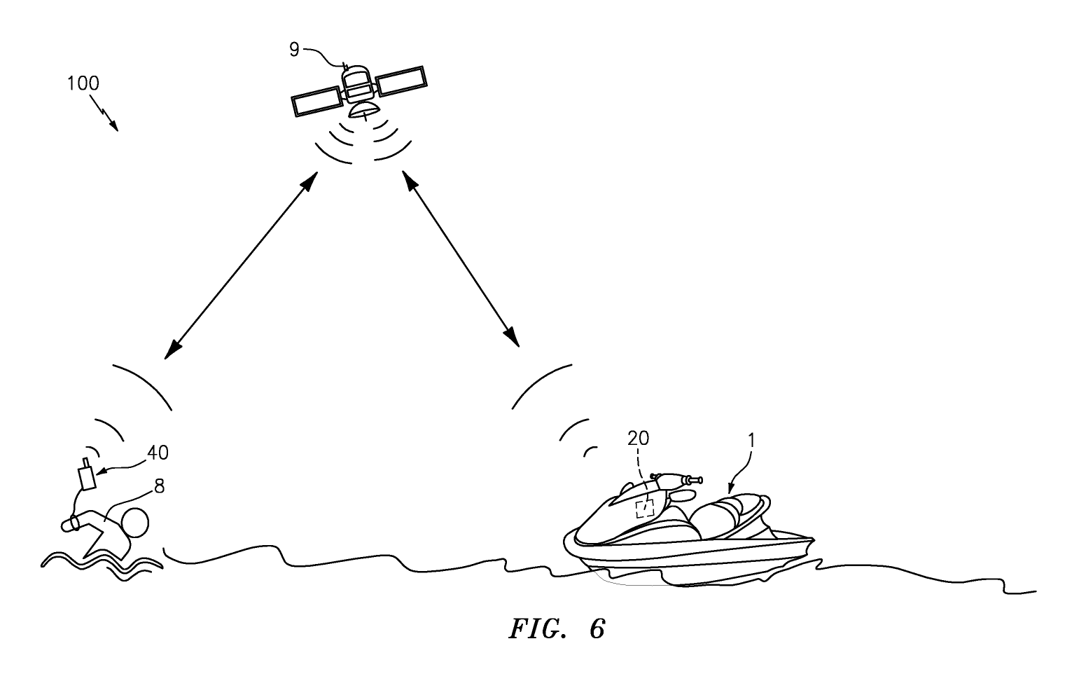

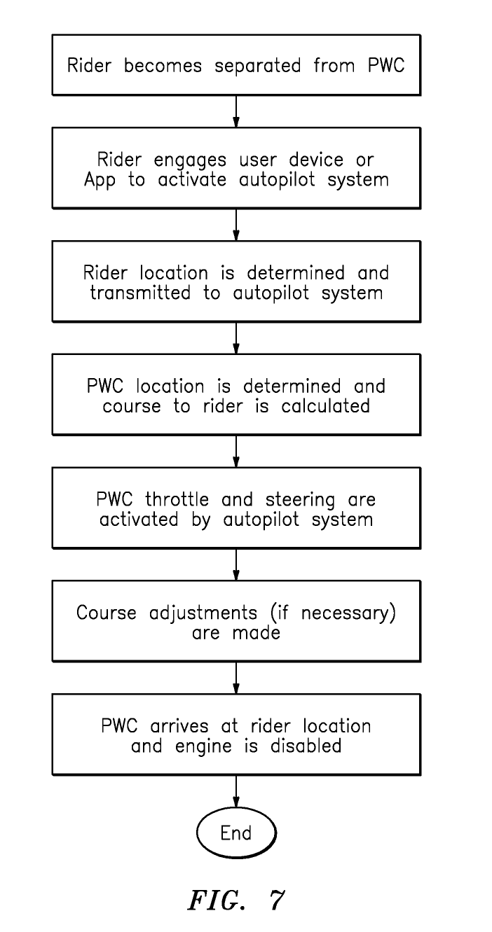

FIGS. 6 and 7 illustrate one embodiment of the system 10 in operation. As shown, when the rider 8 becomes separated from the PWC 1, the device 40 will remain with the user, and the safety switch 41 will be removed from the PWC causing the engine to shut down. If the user is unable or unwilling to swim to the craft, he or she may instruct the autopilot system 20 installed within the craft to pilot the PWC to the user's location.

In one embodiment, this process may be performed wherein the rider selects an appropriate button 58a or screen 58c of the user device 40. At this time, the rider location determination unit 57 can determine the location of the user device via one or more satellites 9. This information, can be sent to the autopilot system 20 via the rider location determination unit and/or the communication unit 53.

Upon receiving the user device location, the autopilot unit 20 can determine the location of the PWC 1 using the onboard PWC location determination unit 22. This information can be provided to the memory and processor, which can determine a course for steering the PWC to the user location, as described above. Once the course has been determined, the throttle module of the ECU can be engaged by the controller and the steering unit 21 can steer the craft. Real time updates can be provided to the unit 20 to make corrections in speed and steering en-route.

Finally, the system can determine that the craft is within a predetermined distance from the user device, such as 5 feet, for example, and can instruct the engine to shift to neutral, hover, reverse and/or shut down.

Although described above as being responsive to a user command, other embodiments are contemplated wherein the system can include functionality for automatically piloting the PWC to the user device upon determining that the rider is not located within a set proximity of the PWC, such as 200 feet, for example.

As described herein, one or more elements of the autopilot unit 20 and user device 40 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A personal watercraft auto-return system, said system comprising:
an autopilot unit that includes
a steering unit that is configured to communicate with a steering device of a personal watercraft,
a first communication unit for performing wireless communication, and
a PWC controller having a processor and memory that are in communication with the steering unit and is configured to communicate with an onboard computer of the personal watercraft; and
a user device that includes
a rider location determination unit, that is configured to determine a location of the user device,
a user interface that is configured to receive a user instruction, and
a second communication unit that is configured to send the determined location of the user device to the first communication unit upon receiving an instruction from the user interface,
wherein upon receiving the determined location of the user device, the PWC controller is configured to selectively activate the steering unit, an engine, and a throttle control of the personal watercraft to navigate the watercraft to the determined location of the user device.

2. The system of claim 1, further comprising:
a PWC location determination unit that is configured to determine a location of the watercraft.

3. The system of claim 2, wherein the PWC location determination unit comprises a satellite location unit.

4. The system of claim 3, wherein the memory is encoded with instructions for comparing the location of the watercraft with the location of the user device, and
to plot a course to the location of the user device.

5. The system of claim 4, wherein the PWC controller is configured to navigate the watercraft to the location of the user device based on the plotted course.

6. The system of claim 5, wherein the satellite location unit is configured to update the location of the watercraft during the navigation, and
wherein the memory is encoded with instructions for updating the plotted course based on the update.

7. The system of claim 1, further comprising:
a kill switch that is configured to detect an orientation of the watercraft.

8. The system of claim 7, wherein the memory is encoded with instructions to not activate the engine of the watercraft upon receiving a notification that the orientation of the watercraft is beyond a predetermined threshold.

9. The system of claim 1, wherein the steering unit comprises:
a steering servo that is mechanically coupled to a steering shaft of the watercraft.

10. The system of claim 9, wherein the steering unit is configured to manipulate a position of the steering shaft along a full range of motion of the steering shaft.

11. The system of claim 1, wherein the user device further comprises:
a safety lanyard having a safety switch for engaging a control input of the watercraft.

12. The system of claim 11, further comprising:
a user attachment mechanism that includes, at least one of a clip and a wristband.

13. The system of claim 1, wherein the PWC location determination unit comprises a satellite location unit.
